(19) United States
(12) Patent Application Publication
(10) Pub. No.: US 2004/0202599 A1
(43) Pub. Date: Oct. 14, 2004

(54) Method of producing nanometer silicon carbide material

(76) Inventors: Ningsheng Xu, Guangzhou City (CN); Zhisheng Wu, Guangzhou City (CN); Shaozhi Deng, Guangzhou City (CN); Jun Zhou, Guangzhou City (CN)

Correspondence Address: THORPE NORTH & WESTERN, LLP., 8180 SOUTH 700 EAST, SUITE 200, P.O. BOX 1219, SANDY, UT, 84070, US

(21) Appl. No.: 10/484,555

(22) PCT Filed: Sep. 24, 2001
(86) PCT No.: PCT/CN01/01449

(30) Foreign Application Priority Data
Jul. 25, 2001 (CN) 01127650.9

(51) Int. Cl. C01B 31/36

(52) U.S. Cl. 423/345

(57) ABSTRACT

This invention relates to a method for preparing nanometer SiC material using nanometer-grade or micron-grade commercial SiC with different shapes, sizes as raw material. The raw materials and catalysts are put into heating device, which is pumped beforehand. Inert gas is let into the heating device as protective gas. The materials and catalysts then will be heated to temperature of 1300˜2000° C., and the temperature preserved for a certain period. The nanorod or nanowire produced can be used in the research and development for SiC photoelectric devices, especially for nanometer photoelectric devices and field emission electron sources. This method features simple operation, low cost, and high yield.

### FIELD OF THE INVENTION

This invention relates to the preparation of a kind of SiC nanomaterial.

### DESCRIPTION OF THE PRIOR ART

The single crystal of SiC has many preferable qualities such as wide band gap, high strength of breakdown voltage, high thermal conductivity, and high saturated electron mobility etc. According to the results of evaluation made using Johnson's semiconductor material evaluation method, the performance of SiC is 260 higher than that of silicon, and is just second to the performance of diamond. The latest researches showed that the elasticity and strength of SiC nanorod are much higher than those of crystal whisker and large block of SiC. Today, a lot of methods have been found to synthesize SiC nanorod. It is possible to synthesize this material through reaction between carbon nanotube and SiO or Sil, or through a two-step reaction, which first produces SiO vapor, and then the SiO vapor reacts with carbon nanotube. These two methods use stable carbon nanotube as template to control the reaction in space, and the SiC nanorods produced have the similar length and diameter with those of the carbon nanotubes that are used as the raw material. Although people expect a lot on these two methods, the high price of carbon nanotube limits the application of this material in mass production of SiC nanowires. Some adopts carbon heating method, which can deoxidate the carbon-containing nanoparticles of silicon dry gel, and succeeded in synthesizing β-SiC nanorod; Others adopts chemical gas sedimentation method, and grow β-SiC nanorod on the silicon base, using solid carbon and silicon as raw materials. Since these two methods need very complicated processes, a simpler, cheaper way of synthesizing SiC nanowires needs to be developed.

### PURPOSE OF THIS INVENTION

This invention aims to provide a simpler and cheaper method for producing SiC nanomaterial.

### TECHNICAL SOLUTIONS OF THIS INVENTION

To achieve the purpose aforementioned, the following processes are adopted in this invention:

1) Put SiC raw material, or the mixture of SiC raw material and catalyst, or the composition of SiC raw material and catalyst, into heating device. Pump the heating device to pressure lower than 5.0×110⁻² torr (including 5.0×10² torr), and let in inert gas as protective gas.

2) Heating to temperature of 1300˜2000° C., and then keep the temperature for 5 mins to 2 hours.

The catalyst used in above step is Al or Fe. The experiment steps and conditions are the same for different catalysts used in this invention.

We conducted SEM, TEM and Raman spectroscopy on the SiC material produced using the above-mentioned method. The SiC raw material heated in Ar gas, the mixture of SiC raw material and catalyst, and the composition of SiC raw material and catalyst all showed the structure of SiC nanorod and nanowire, which minimum diameter reached 5 nm, and maximum length reached 5 μm. The nanometer structure of above-mentioned SiC distributed in the vertical direction of the raw material surface, and showed a certain alignment. This method is simpler, asking for less requirements on equipments, thus is cheaper method for producing SiC nanorods and nanowires.

### DRAWINGS

FIG. 1: SEM picture of the surface of SiC particle (Ar gas, Al as catalyst, temperature reservation for 100 min.)

FIG. 2: SEM picture of the surface of SiC particle (Ar gas, Al as catalyst, temperature reservation for 40 min.)

FIG. 3: SEM picture of the surface of SiC particle (Ar gas, Al as catalyst, temperature reservation for 60 min.)

FIG. 4: TEM picture of SiC nanowire (Ar gas, Fe as catalyst, temperature reservation for 60 min.)

FIG. 5: SEM picture of SiC nanowire with ordered structure.

FIG. 6: I-E curve of SiC nanowire produced using Al as catalyst.

FIG. 7: I-E curve of SiC nanowire produced using iron as catalyst.

### PREFERRED EMBODIMENTS

Take SiC powder (particle diameter 30-50 micron) as raw material and Fe as catalyst; put them into heating device, and pump the device to pressure less than 5.0×10⁻² torr. Let in Ar inert gas as protective gas, and then heat to temperature of 1300° C., 1400° C., 1500° C., 1600° C., 1700° C. and 2000° C., respectively The time for temperature reservation is 5, 10, 30, 60, 80, 100 and 120 minutes respectively. The results are shown in the table. Under these conditions, we have achieved nanometer structure of SiC.

In our experiments, we have succeeded in synthesizing nanorod and nanowire of SiC through heat evaporation method using commercial SiC as raw material, and the nanowire and nanorod have grown in large area on the surface of raw material SiC.

TABLE 1
Results under different time period and temperature

| | Time | | | | | | |
|---|---|---|---|---|---|---|---|
| | 5 min | 10 min | 30 min | 60 min | 80 min | 100 min | 120 min |
| Temp. | Effect | | | | | | |
| 1300° C. | Nanometer | Nanometer | Nanometer | Nanometer | Nanometer | Nanometer | Nanometer |
| | structure | structure | structure | structure | structure | structure | structure |
| | of SiC | of SiC | of SiC | of SiC | of SiC | of SiC | of SiC |
| | observed | observed | observed | observed | observed | observed | observed |
| 1400° C. | Nanometer | Nanometer | Nanometer | Nanometer | Nanometer | Nanometer | Nanometer |
| | structure | structure | structure | structure | structure | structure | structure |
| | of SiC | of SiC | of SiC | of SiC | of SiC | of SiC | of SiC |
| | observed | observed | observed | observed | observed | observed | observed |
| 1500° C. | Nanometer | Nanometer | Nanometer | Nanometer | Nanometer | Nanometer | Nanometer |
| | structure | structure | structure | structure | structure | structure | structure |
| | of SiC | of SiC | of SiC | of SiC | of SiC | of SiC | of SiC |
| | observed | observed | observed | observed | observed | observed | observed |
| 1600° C. | Nanometer | Nanometer | Nanometer | Nanometer | Nanometer | Nanometer | Nanometer |
| | structure | structure | structure | structure | structure | structure | structure |
| | of SiC | of SiC | of SiC | of SiC | of SiC | of SiC | of SiC |
| | observed | observed | observed | observed | observed | observed | observed |
| 1700° C. | Nanometer | Nanometer | Nanometer | Nanometer | Nanometer | Nanometer | Nanometer |
| | structure | structure | structure | structure | structure | structure | structure |
| | of SiC | of SiC | of SiC | of SiC | of SiC | of SiC | of SiC |
| | observed | observed | observed | observed | observed | observed | observed |
| 2000° C. | Nanometer | Nanometer | Nanometer | Nanometer | Nanometer | Nanometer | Nanometer |
| | structure | structure | structure | structure | structure | structure | structure |
| | of SiC | of SiC | of SiC | of SiC | of SiC | of SiC | of SiC |
| | observed | observed | observed | observed | observed | observed | observed |

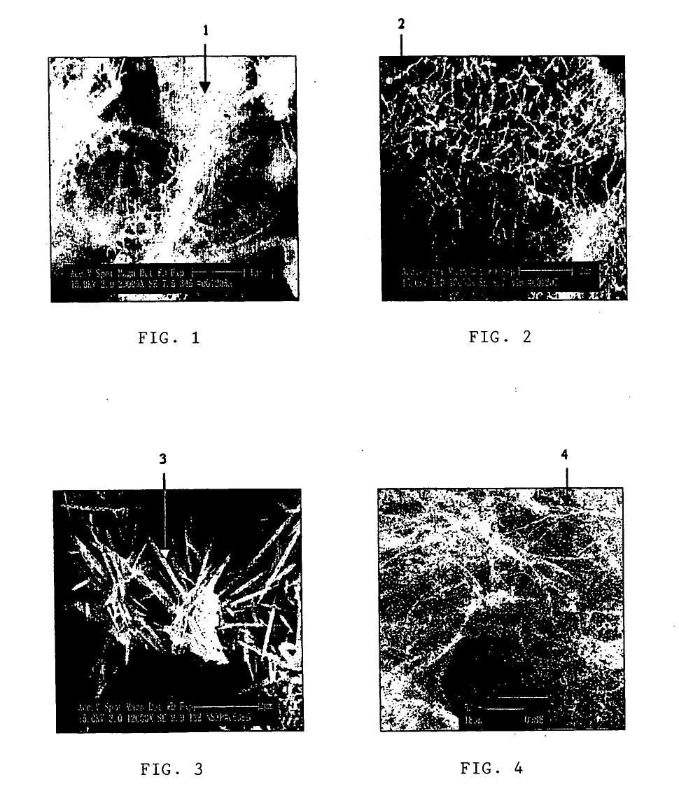

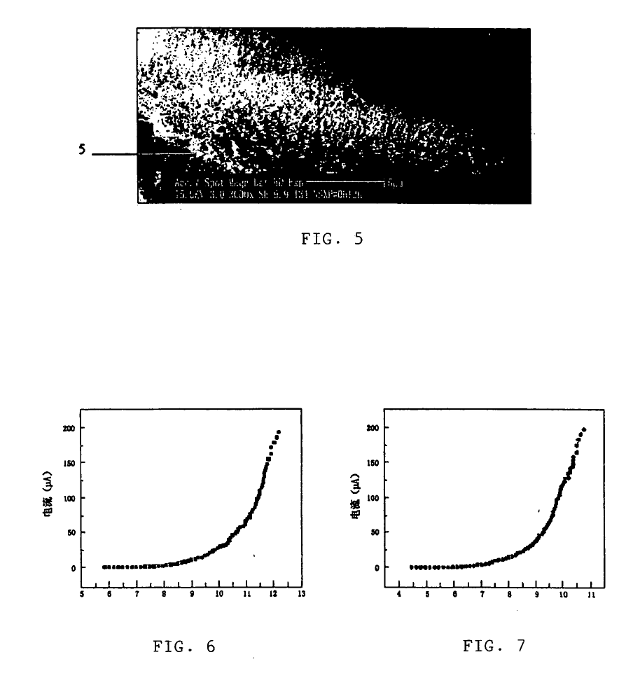

In FIGS. 1 to 4, the item 1, 2, 3, and 4 are the nanowire structure of SiC produced using the above-mentioned methods. The minimum diameter reached 5 nm and the maximum length reached 5 μm. Raman spec troscopy showed that these nanometer structures are SiC, and the TEM analysis showed the structures are crystal structures. From FIG. 5, we can see that the nanometer structure grows in the vertical direction of the surface of SiC particles, and has certain alignment. In FIG. 5, the arrow No.5 indicates the surface of SiC particle. FIGS. 6 and 7 showed the results of application of above-mentioned materials in field electron emission. FIG. 6 is the I-E curve of SiC nanowire produced using Al as catalyst, and FIG. 7 is is the I-E curve of SiC nanowire produced using Fe as catalyst. From these two figues, we can see that this material has lower emission voltage and high emission current, and its turn-on field and threshold field are similar with that of carbon nanotube, thus can completely satisfy the requirements for field electron emission material. In addition, since this nanomaterial has all the physical and chemical characteristics of large silicon block, it can be applied in the areas of nano-components, high-power photoelectric devices, and high-power field electron emission.

1. A method to prepare nanometer SiC material, which processes include:
a) Put SiC raw material, or the mixture of SiC raw material and catalyst, or the composition of SiC raw material and catalyst, into heating device.
Pump the heating device to pressure less than 5.0×10⁻² torr, and let in inert gas as protective gas.
b) Heating to temperature of 1300˜2000° C., and then keep the temperature for 5 mins to 2 hours.

2. The method to prepare SiC nanomaterial, which is described in claim 1, uses nanometer-grade or micron-grade commercial SiC with different shapes, sizes as raw material.

3. The inert gas used is Ar gas.

4. The catalyst used is Al or Fe.
